(19) United States
(12) Patent Application Publication
(10) Pub. No.: US 2016/0295390 A1
(43) Pub. Date: Oct. 6, 2016

(54) CENTRALISED CAPABIITY DISCOVERY

(71) Applicant: TELEFONAKTIEBOLAGET LM ERICSSON (PUBL), Stockholm (SE)

(72) Inventor: Ester GONZALEZ DE LANGARICA, Stockholm (SE)

(73) Assignee: Telefonaktiebolaget L M Ericsson (publ), Stockholm (SE)

(21) Appl. No.: 15/038,130

(22) PCT Filed: Nov. 22, 2013
(86) PCT No.: PCT/SE2013/051377

§ 371 Date: May 20, 2016

(51) Int. Cl. H04W 8/00; H04W 4/16; H04M 1/2745; H04L 12/24

(52) U.S. Cl. CPC H04W 8/005; H04L 41/0866; H04W 4/16; H04M 1/274516; H04M 1/274508; H04W 80/04

(57) ABSTRACT

According to aspects of the invention there are provided methods and apparatus for use in a communication network (301) to enable a user to determine the applications that are used by other users in said user's address book contact information. The application(s) are installed on the user equipment (304) of the other users. The network (301) includes a contact information server (302) and a plurality of user equipment (303, 304) associated with the user and the other users. The contact information server (302) receives, from a user equipment (303) of a first user or a network entity on behalf of the first user, a capabilities request message for an indication of applications used by one or more other users in the address book contact information of the first user. The contact information server (302) queries a contact information database (305) and determines the application(s) used or installed by the one or more other users in the address book contact information of the first user. The contact information server (302) transmits a capabilities response message comprising capability information representative of the determined application(s)to said user equipment (303) of the first user or said network entity for display of the capabilities information to the first user.

### TECHNICAL FIELD

The present invention relates to methods and apparatus for providing a user with an indication of the application(s) used by other users in the address book contact information of said user.

### BACKGROUND

The IP Multimedia Subsystem (IMS) is the technology defined by the Third Generation Partnership Project (3GPP) to provide IP Multimedia services over mobile communication networks. IP Multimedia services provide a dynamic combination of voice, video, messaging, data, etc. within the same session.

The IMS makes use of the Session Initiation Protocol (SIP) to set up and control calls or sessions between user terminals. The Session Description Protocol (SDP), carried by SIP signals, is used to describe and negotiate the media components of the session. Whilst SIP was created as a user-to-user protocol, the IMS allows operators and service providers to control user access to services and to charge users accordingly.

FIG. 1 illustrates schematically how the IMS fits into the mobile network architecture in the case of a General Packet Radio Service (GPRS) access network. As shown in FIG. 1, a control of communications occurs at three layers (or planes). The lowest layer is the Connectivity Layer 1, also referred to as the bearer plane and through which signals are directed to/from user equipment (UE) accessing the network. The entities within the connectivity layer 1 that connect an IMS subscriber to IMS services form a network that is referred to as the IP-Connectivity Access Network, IP-CAN. The GPRS network includes various GPRS Support Nodes (GSNs). A gateway GPRS support node (GGSN) 2a acts as an interface between the GPRS backbone network and other networks (radio network and the IMS network). The middle layer is the Control Layer 4, and at the top is the Application Layer 6.

The IMS 3 includes a core network 3a, which operates over the middle, Control Layer 4 and the Connectivity Layer 1, and a Service Network 3b. The IMS core network 3a includes nodes that send/receive signals to/from the GPRS network via the GGSN 2a at the Connectivity Layer 1 and network nodes that include Call/Session Control Functions (CSCFs) 5, which operate as SIP proxies within the IMS in the middle, Control Layer 4. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF. The top, Application Layer 6 includes the IMS service network 3b. Application Servers (ASs) 7 are provided for implementing IMS service functionality.

The UE may comprise or represent any device used for communications. Examples of UE that may be used in certain embodiments of the described network(s) are wireless devices such as mobile phones, terminals, smart phones, portable computing devices such as lap tops, handheld devices, tablets, netbooks, computers, personal digital assistants and other wireless communication devices, or wired communication devices such as telephones, computing devices such as desktop computers, set-top boxes, and other fixed communication devices.

Communication networks may comprise or represent any network used for communications with UEs connected to the communications network. Examples of communications networks include, but are not limited to, wireless networks such as the Worldwide Interoperability for Microwave Access (WiMAX), wireless local area networks (WLAN) based on the Institute of Electrical and Electronics Engineers' (IEEE) 802.11 standards e.g. Wi-Fi networks, or Internet Protocol (IP) networks, packet-switched networks or enhanced packet switched networks, IMS networks, or communications networks based on wireless, cellular or satellite technologies such as mobile networks, Global System for Mobile Communications (GSM), Wideband Code Division Multiple Access (VV-CDMA), CDMA2000 or Long Term Evolution (LTE)/LTE Advanced mobile networks or any 2^{nd}, 3^{rd} or 4^{th} Generation and beyond communications networks.

Nowadays the Rich Communication Suite 5.1 standard defines two mechanisms to exchange UE capabilities, including both basic communication services and applications. IMS basic communication services (IMS CoSe) are identified by an IMS communication service identifier (ICSI), and applications are identified as an IMS application reference identifier (IARI). There are two mechanisms that may be used to exchange capabilities, one is based on the OPTIONS mechanism and the other one is based on the Presence mechanism as outlined in section 2.6 of the RCS 5.1 standard. After the capabilities exchange process takes place, the address book contact information of a user is populated with the contact service capabilities. Then a particular application installed in the UE, e.g. a chess game, can access this locally stored information to show the list of potential partners from the user's address book contact information.

In particular, when a user installs a new application on his UE (e.g. a mobile phone), the application may use one or several underlying IMS CoSes. When the user starts the application, the application user interface (UI) typically shows the list of contacts in the user's address-book or address book contact information that have the same application installed i.e. users that have the same capability, identified by an IMS application reference identifier. For example, a user may install a multiparty game application on their UE, when the user starts the application, the UI will typically show the list of contacts he can play the game with. The address-book must always be (re)populated to reflect the contacts in the user's address-book having the new application. This process may be initiated just after the game is installed or when the user starts the application.

This means that every time a new application that makes use of the IMS CoSe is installed or started in one of the user's UEs, the capability exchange process must take place. However, the complete (re)population of the address book has a negative impact in both the user's UE and the communications network or IP network. This impacts the UE battery because the capability exchange process runs as a background task, and for each contact in the address-book the UE must send a request and process the responses. This impacts the network due to high traffic load in the network, e.g. user-network-interface (UNI) and the network-network-interface (NNI). The impact is more severe the larger the address book. This also leads to wastage of network resources because once the address-book (re)population is completed, the user may find out that none of his contacts has the new application (i.e. this capability) available, in which case the user will most likely uninstall it and try another application with similar functionality (e.g. another multi -party game). This is a waste of (not chargeable) signalling in the network, battery and the user's patience.

FIG. 2 is a signalling flow diagram illustrating the impact on an IP network due to (re)population of the address book contact information when a new application is installed or used for the first time. The IP network includes an IMS core network A and an IMS core network B and a plurality of UEs and corresponding users. IMS core network A includes a first user (“Anna”) and the UE and IMS core network B includes a second set of other users (“Bob”, “Eva”, “Mark”, etc.) and their associated UEs.

In operation, the first user (“Anna”) installs a new application (e.g. game XYZ) and (re) population of her whole address book contact information takes place. It is assumed the other users (“Bob”, “Eva”, “Mark”, etc.) are in Anna's address book contact information. This process may be initiated just after the new application is installed on Anna's UE or when Anna starts the application. In this example, the OPTIONS mechanism for capability discovery is shown (it could also be the Presence mechanism). This means that for each contact or user in Anna's address book contact information, a SIP OPTIONS message is sent to the IMS CN-A, then forwarded to IMS CN-B and then forwarded to the corresponding UE. For example, a SIP OPTIONS(Bob, Anna capabilities) message is sent via IMS CN-A/B to Bob's UE, a SIP OPTIONS(Eva, Anna capabilities) message is sent via IMS CN-A/B to Eva's UE, a SIP OPTIONS(Mark, Anna capabilities) message is sent via IMS CN-A/B to Mark's UE, and so on. Anna's contacts then all respond with a SIP message, e.g. 200 OK capabilities message. For example, Bob's UE sends Anna's UE, via IMS CN B/A, an 200 OK (Bob Capabilities) message, Eva's UE sends Anna's UE, via IMS CN B/A, an 200 OK (Eva Capabilities) message, Mark's UE sends Anna's UE, via IMS CN B/A, an 200 OK (Mark Capabilities) message. This simple (re) population example results in a large wastage of network resources both in NNI and UNI.

When user “Anna” starts or uses the application, she can then see the list of users having the application (e.g. game XYZ) as a capability. Note, if a user such as user “Mark” is not shown in the list, then this means that “Mark” does not have the application (e.g. game XYZ) among his capabilities—i.e. game XYZ is not installed on Mark's UE. If user “Anna” considers there are too few friends having this application installed to make it attractive, she may then decide to uninstall the application and try with another application with a similar functionality, and so the (re) population is performed again on the next application and so on.

With existing technology, the user can only make ill-formed decisions when installing a particular application as they do not and cannot know in advance how many of their contacts or other users in their address book contact information are able to use the application. The use has to first install and start the application so a capabilities exchange takes place as described above, which clearly wastes network resources, reduces battery life of the user's UE, and provides unsatisfactory use experience. There is a desire to reduce the signaling waste, improve the battery performance of the UE, and improve the user experience when selecting an application for installation/use on a user's UE.

### SUMMARY

It is an object of the present invention to provide methods and apparatus of providing a first user with applications used by other users listed in the address book contact information of the first user to minimise the communications resources of a communications network, and thereby optimising the performance of the communications network by reducing signalling wastage. In particular, the present invention relates to methods and apparatus for optimising the performance of a communications network such as an IP network using a contact information server and database of address book contact information to determine the applications used by the other users from the first user's address book contact information, in which a summary or digest of the determined applications used by the other users is displayed to the first user.

According to a first aspect of the invention there is provided a method for use by a contact information server in a communications network, the communications network including the contact information server and a plurality of UE. The contact information server is coupled to a database of address book contact information associated with users of the UE in the communications network. Each user has address book contact information associated with one or more other users and each UE has one or more application(s) installed. The method includes receiving a capabilities request message from an apparatus associated with a first user for an indication of the applications used by one or more other users in the address book contact information of the first user. Determining the application(s) used or installed by the one or more other users in the address book contact information of the first user. Transmitting a capabilities response message to the apparatus associated with the first user, the capabilities response comprising capability information representative of the determined application(s) for use in displaying to the first user.

As an option, determining the application(s) used further comprises estimating the number of one or more other users in the address book contact information of the first user that use each of the determined applications, wherein the capability information further includes information representative of the number of one or more other users using each determined application. Optionally, determining the applications used further comprises estimating a percentage of the one or more other users that use each of the determined application(s), wherein the capability information further includes the estimated percentages for each of the determined application(s). As another option, the method further comprises determining the download location of each of the determined application(s), wherein the capability information includes the determined download location(s) of the determined application(s).

Optionally, the capabilities request message and the capabilities response message are based on the XCAP protocol. Additionally, the capabilities request message may be an XCAP GET message and the capabilities response message is an XCAP 200 OK message. As an option, the capabilities request message may be embedded in a SIP request message and the capabilities response message may be embedded in a SIP response message.

As an option, a UE of the first user comprises the apparatus, where the capabilities request message is received from the UE of the first user, and the capabilities response message is transmitted to the UE of the first user, wherein the UE displays the capability information to the first user. As another option, a network entity comprises the apparatus, wherein the capabilities request message is received from a network entity on behalf of the first user, and the capabilities response message is transmitted to the network entity, wherein the network entity displays the capability information to the first user.

According to a second aspect of the invention there is provided a method for operating an apparatus associated with a first user in an communications network comprising a contact information server. The contact information server is coupled to a database of address book contact information associated with the first user and a plurality of users of UE. Each user has address book contact information associated with one or more other users and each UE has one or more application(s) installed. The method includes transmitting a capabilities request message to the contact information server for an indication of applications that are used by one or more other users in the address book contact information of the first user. Receiving a capabilities response message from the contact information server, the capabilities response message comprising capability information representative of the application(s), as determined by the contact information server, that are used by the one or more other users in the address book contact information of the first user. Displaying the usage of the determined application(s) to the first user based on the received capability information.

As an option, the capability information further includes information representative of the number of one or more other users that use each determined application. Additionally or alternatively, the capability information further includes an estimated percentage of the one or more other users that use each of the determined application(s) on the corresponding UE. Additionally or alternatively, the capability information further includes download location(s) of the determined application(s).

As an option, the capabilities request message and the capabilities response message are based on the XCAP protocol. Additionally, the capabilities request message may be an XCAP GET message and the capabilities response message is an XCAP 200 OK message. Additionally or alternatively, the capabilities request message may be embedded in a SIP request message and the capabilities response message is embedded in a SIP response message.

Optionally, a UE of the first user comprises the apparatus. Alternatively or additionally, a network entity operating on behalf of the first user comprises the apparatus.

According to a third aspect of the invention there is provided contact information server for use in a communication network comprising a plurality of UE. The contact information server is coupled or has access to a database of address book contact information associated with users of the plurality UE. Each user has address book contact information associated with one or more other users and each UE has one or more application(s) installed. The contact information server includes a processor, receiver, transmitter and memory, the processor being coupled to the receiver, the transmitter and the memory. The receiver is configured to receive a capabilities request message from an apparatus associated with a first user for an indication of applications used by one or more other users in address book contact information of the first user. The processor comprises determining logic configured to determine the application(s) that are used by the one or more other users in the address book contact information of the first user. The transmitter is configured to transmit a capabilities response message to the apparatus associated with the first user, the capabilities response comprising capability information representative of the determined application(s) for display to the first user.

As an option, the determining logic is further configured estimate the number of one or more other users in the address book contact information of the first user that use each of the determined applications, wherein the capability information includes information representative of the number of one or more other users that use each determined application. Optionally or additionally, the determining logic is further configured to estimate a percentage of the one or more other users in the address book contact information of the first user that use each of the determined application(s), wherein the capability information includes the estimated percentages for each of the determined application(s). Additionally or alternatively, the determining logic is further configured to determine the download location of each of the determined application(s), where the capability information includes the determined download location(s) of the determined application(s).

Optionally, the capabilities request message and the capabilities response message are based on the XCAP protocol. As an option, a UE of the first user comprises or includes the apparatus. As another option, a network entity operating on behalf of the first user comprises or includes the apparatus.

According to a fourth aspect of the invention there is provided an apparatus for use in a communications network comprising a contact information server. The contact information server is coupled to a database of address book contact information associated with a plurality of users and associated UE in the network. Each user has address book contact information associated with one or more other users and each UE has one or more application(s) installed. The apparatus includes a processor, receiver, transmitter, and memory, the processor being coupled to the receiver, the transmitter, and the memory. The transmitter configured to transmit a capabilities request message to the contact information server for an indication of applications used by one or more other users in the address book contact information of a first user of said UE. The receiver is configured to receive a capabilities response message from the contact information server, the capabilities response message comprising capability information representative of the application(s), as determined by the contact information server, that are used by the one or more other users in the address book contact information of the first user. The processor is configured to process the capability information for displaying the capability information to the first user.

Optionally, the capability information further includes information representative of the number of one or more other users that use each of the determined application(s). As another option, the capability information further includes an estimated percentage of the one or more other users that use each of the determined application(s). As a further option, the capability information includes download location(s) of the determined application(s).

As an option, the capabilities request message and the capabilities response message are based on the XCAP protocol. Additionally or alternatively, a UE of the first user comprises the apparatus, where the UE includes a display for displaying the capability information. Optionally, a network entity operating on behalf of the first user comprises the apparatus, and operates to display the capability information to the first user.

According to further aspect of the invention there is provided a computer program, comprising computer readable code means which, when run from a computer readable medium in the form of a memory in a processor in a server, causes the server to perform the methods or processes as described. Additionally or alternatively, there is provided a computer program product comprising a computer readable medium and a computer program as described, where the computer program is stored on the computer readable medium.

According to another aspect of the invention there is provided a computer program, comprising computer readable code means which, when run from a computer readable medium in the form of a memory in a processor in an apparatus, causes the apparatus to perform the methods or processes as described. As an option, there is provided a computer program product comprising a computer readable medium and a computer program as described, where the computer program is stored on the computer readable medium.

It is evident that the invention provides the advantage of providing a user of a UE with the necessary information about applications available among the contacts, or address book contact information of the user, allowing the user to make informed decisions before downloading and installing applications on their UE. This provides the further advantages of reducing wastage of communications resources, namely network bandwidth and load, and improves the performance of the UE such as the battery life of the UE because of the substantial reduction of the number of requests require to inform the user of the capabilities of contact or users in the user's address book contact information.

### BRIEF DESCRIPTION OF THE DRAWINGS

FIG. 1 is a diagram illustrating a typical communications network;

FIG. 2 illustrates schematically a signalling flow diagram of a prior art system for notifying the type of applications used by other users in user's address book contact information;

FIG. 3a is a signalling flow diagram illustrating an example process of providing application usage of other users to the user according to the present invention;

FIG. 3b is a signalling flow diagram illustrating another example process of providing application usage of other users to the user according to the present invention;

FIG. 3c is a signalling flow diagram illustrating a further example process of providing application usage of other users to the user according to the present invention;

FIG. 4a is a flow diagram illustrating an example process performed by a server according to the present invention;

FIG. 4b is a flow diagram illustrating another example process performed by a server according to the present invention;

FIG. 4c is a flow diagram illustrating a further example process performed by a server according to the present invention;

FIG. 4d is a flow diagram illustrating yet a further example process performed by a server according to the present invention;

FIG. 5a is a flow diagram illustrating an example process performed by an apparatus according to the present invention;

FIG. 5b is a flow diagram illustrating another example process performed by an apparatus according to the present invention;

FIG. 5c is a flow diagram illustrating a further example process performed by an apparatus according to the present invention;

FIG. 5d is a flow diagram illustrating yet a further example process performed by an apparatus according to the present invention;

FIG. 6 is a schematic illustration of an example server according to the invention; and

FIG. 7 is a schematic illustration of an example apparatus according to the invention.

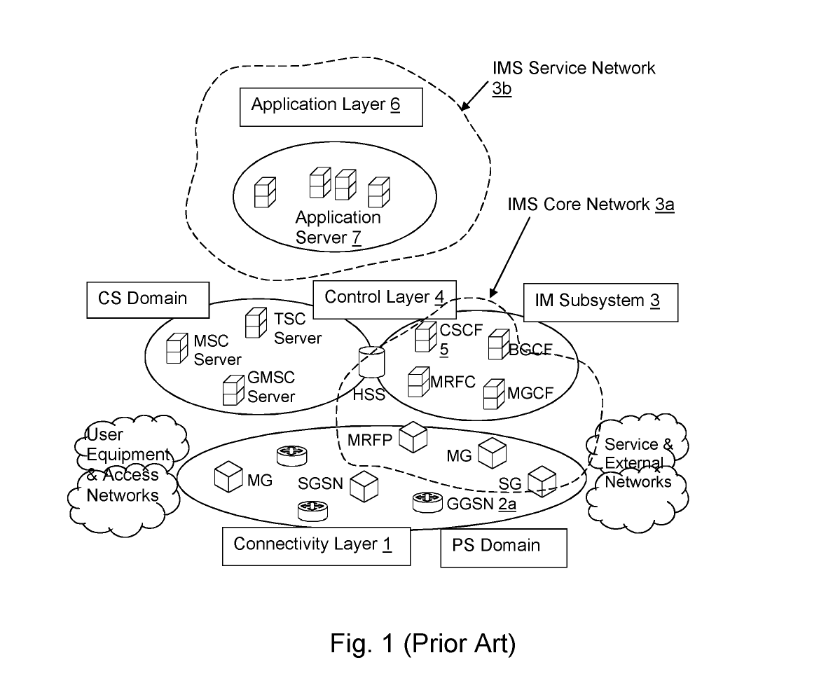

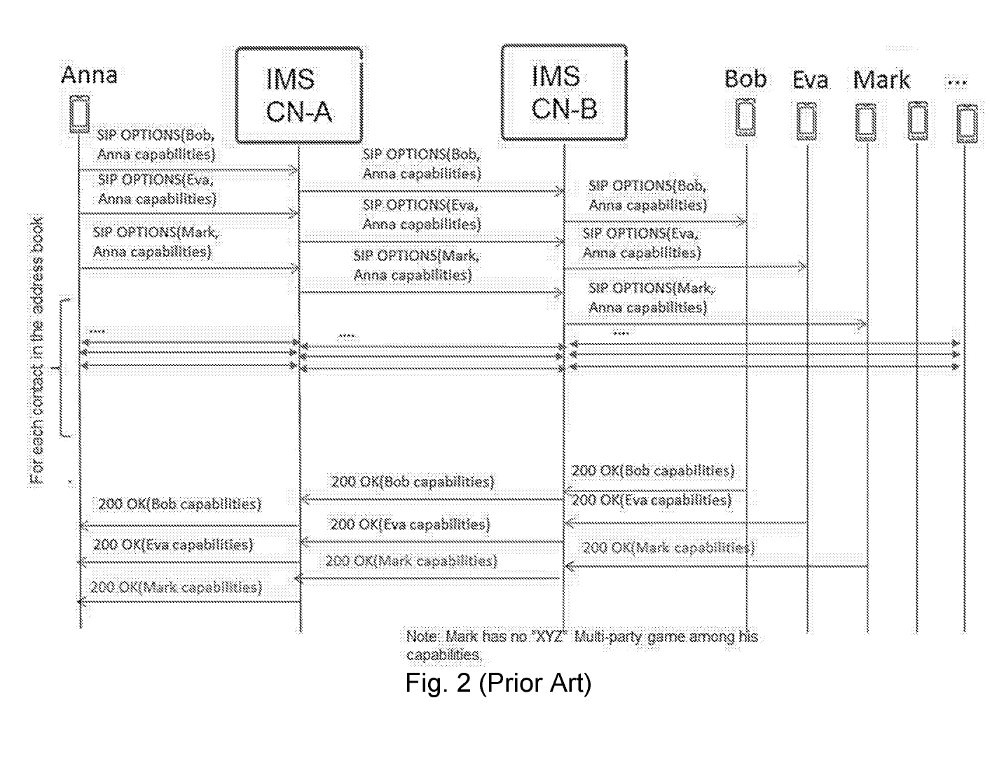

### DETAILED DESCRIPTION

In order to at least partially overcome the problems described above, it is proposed herein to improve the performance of an communications network (e.g. an IP communications network) by providing, when requested, a user with an indication or an information digest of the application(s) used by other users in their address book contact information. In this way, a user may select an application that is used by one or more other users in their address book contact information avoiding a plurality of query messages to all other users in that user's address book contact information to determine whether any of the other users have or use the application. The invention consists of a mechanism provided by the network for allowing a user's UE to make a request about the most popular capabilities of the contacts or users in their address book contact information, and getting a digested answer back.

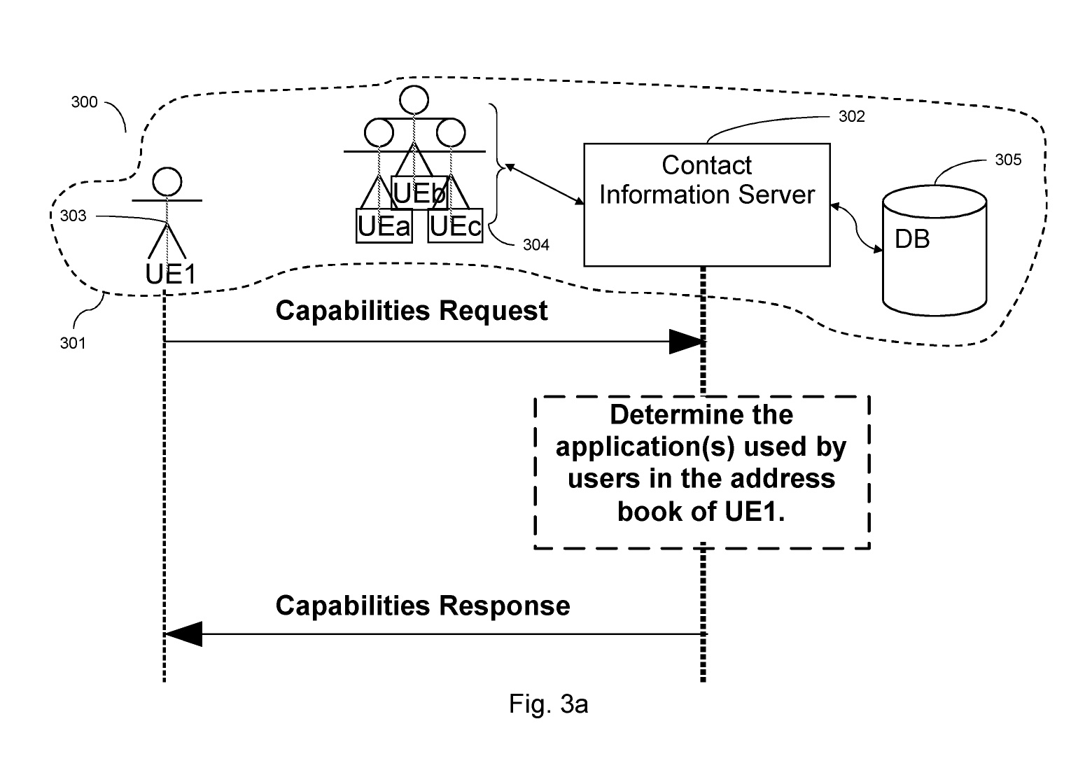

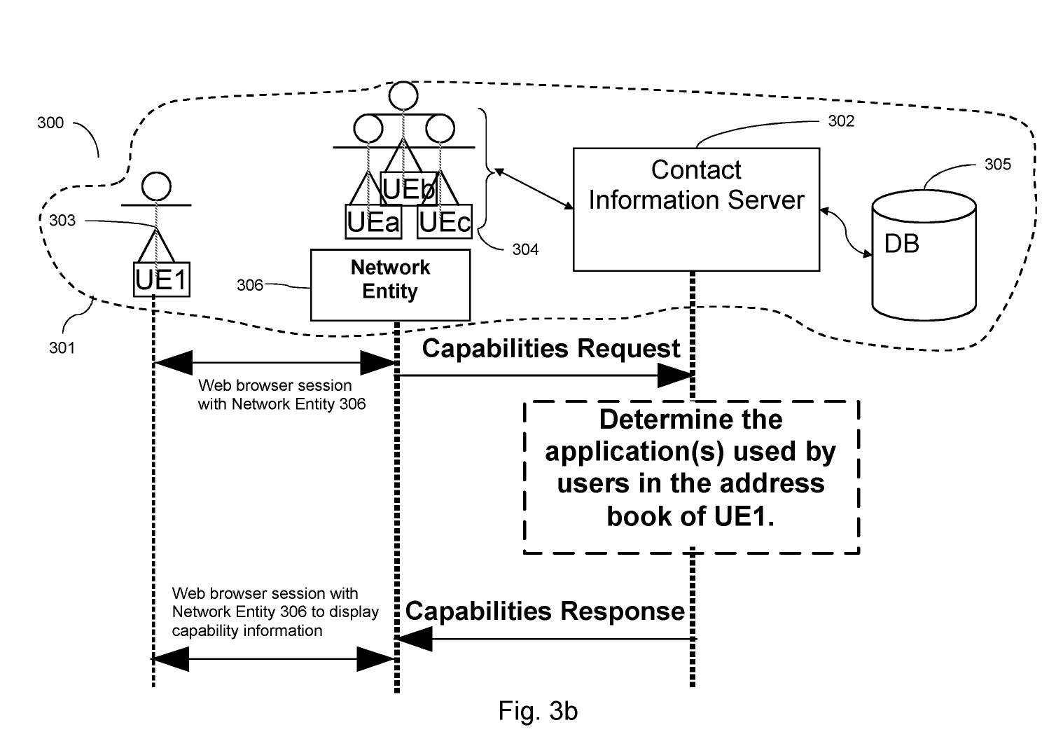

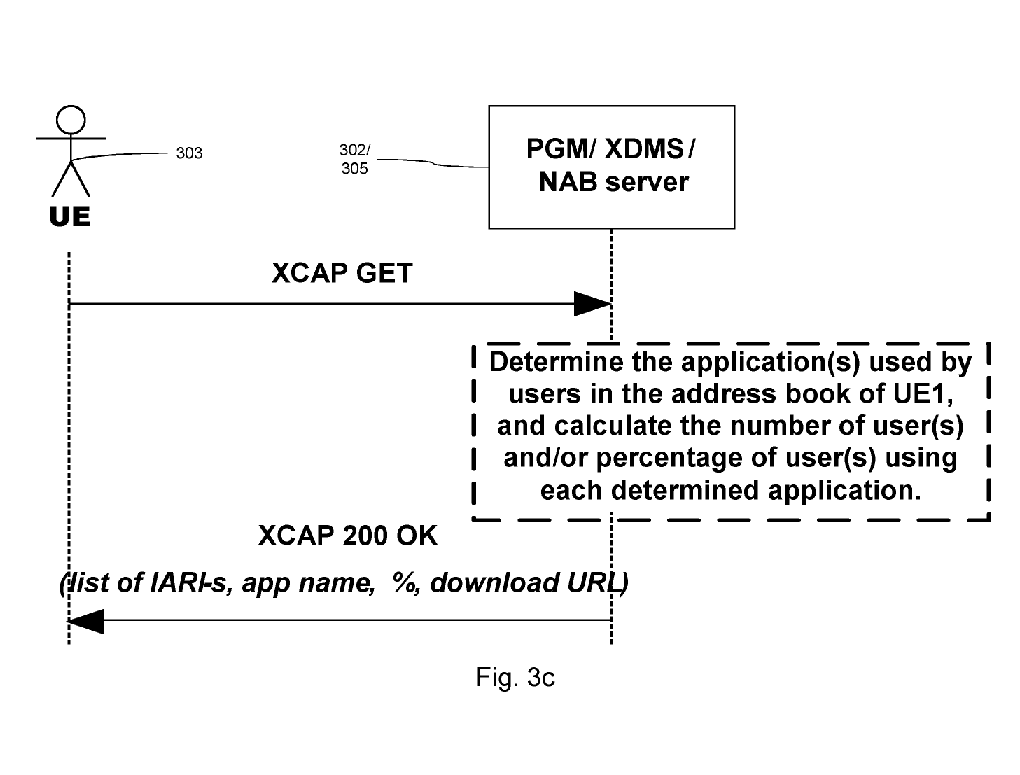

FIG. 3a is a schematic illustration of a communications system 300 that includes an IP network 301 with a contact information server 302 and a plurality of users and their associated UEs (UEs) 303 and 304. The contact information server 302 is coupled to a database 305 of address book contact information associated with the users. One or more application(s) may be installed on one or more of the UEs associated with the other users, and the address book contact information of the users is stored in database 305 that is accessible by contact information server 302. The address book contact information for a user may include data representative of the applications installed or used by that user (e.g. capabilities of the users such as IARIs etc.).

The contact information server 302 may be an application server within the communication system 300 that has access to database 305 of address book contact information, which may be used to store capabilities of the UEs 303, 304 for each user. The address book contact information may comprise, but is not limited to, an aggregated list for each user storing data representative of UE identities, capabilities of UE, user contacts and capabilities of a user's contacts or other users. This means the capabilities of a user's contacts or the UE of the user's contacts may be stored in the network in the database of address book contact information. The database 305 of address book contact information may be located within the contact information server 302 or may be distributed in various storage media or one or more databases or servers throughout the communications system 300 and IP network 301. As an example, in RCS 5.1 the database 305 of address book contact information may be a network address book (NAB) system that stores an aggregated list for each user and UE and the capabilities of user's contacts in the network. The database 305 of address book contact information may be populated when a change in the capabilities of a UE occurs, for example, the UE sends the new capabilities to an application server or Presence Gateway Management (PGM) in the network, which then populates the database 305 accordingly. Effectively, the service capabilities or capabilities for all the contacts in the user address book contact information (user address book contacts) are made available via the database 305, e.g. via a NAB system.

In operation, the contact information server 302 receives, from a UE 303 of a first user of the plurality of users, a capabilities request query or message for an indication of applications used by one or more other users of the plurality of users that are in the address book contact information associated with the first user. The contact information server 302 queries the database 305 for data representative of the one or more other users and the corresponding applications used by the one or more other users from the address book contact information. Based on the data received from the database 305, the contact information server 302 determines the application(s) used by the one or more other users and/or the application(s) installed on the UEs 304 of the one or more other users.

The contact information server 302 transmits a capabilities response message comprising capability information representative of the determined application(s) to the first user's UE 303. The UE 303 of the first user displays the capability information to said first user an appropriate format. The capability information may be a summary or an information digest of the determined application(s). From this digest, the first user may select an application for use on the first user's UE 303 without the need for the application to send a multiplicity of queries into the IP network to determine whether any other user in the first user's address book contact information is using the selected application.

In determining the applications that are used by the one or more other users, the contact information server 302 may calculate the number of users that use each determined application. For example, the contact information server 302 may estimate the number of one or more other users in the address book contact information of the first user that use each of the determined applications. The content information server 302 may then send a capabilities response message including capability information representative of the determined applications and the number of one or more other users using each determined application.

Alternatively or additionally, the contact information server 302 may calculate the percentage of users in the address book contact information that use each determined application. For example, the contact information server 302 may estimate the percentage of one or more other users in the address book contact information of the first user that use each of the determined applications. The content information server 302 may then send a capabilities response message including capability information representative of the determined applications and the number of one or more other users using each determined application. Alternatively or additionally, the contact information server 302 may determine the download location of each of the determined application(s), where the capability information includes the determined download location(s) of the determined application(s).

For example, when the UE makes a query to the network requesting the most popular applications among the contacts or users in the address book contact information, the network may determine and send a response message with data representative of the determined applications used, the percentage of users in the address book contact information of the user of the UE, and a download location, which may take the following form:

MyChess app: 20%, http://www.myChess.com/download
Zombies game 50%, http://www.zombiesgame.com/download
Poker game 20%, http://www.pokergame.com/download
RunnerApp 63%, http:///www.runnerapp.com/download
XYZ Multi Party game: 5%,
http://www.xyzMultiPartyGame.com/download
etc.

The mechanism according to the invention means that users are able to receive information about the applications available among the contacts or users in their address book contact information. This allows all users to make better decisions before downloading and installing the various applications available to them, which reduces and saves resources in the communications networks and also improves UE battery life.

FIG. 3b is another schematic illustration of communications system 300 that includes an communications network 301 with the contact information server 302 and the plurality of users and their associated UEs (UEs) 303 and 304, and a network entity 306. As previously described, the contact information server 302 is coupled to the database 305 of address book contact information associated with the users. One or more application(s) may be installed on one or more of the UEs associated with the other users, and the address book contact information of the users is stored in database 305 that is accessible by contact information server 302. The address book contact information for a user may include data representative of the applications installed or used by that user (e.g. XCAP or Presence capabilities of the users such as IARIs etc.).

In operation the contact information server 302 operates as previously described.

However, in this scenario, the network entity 306 could be another application server or web server that hosts an online application store. The first user of UE 303 may be browsing the application store via a web browser and indicates an application of interest. Instead of the UE 303 of the first user downloading the application and then sending the capabilities request query for an indication of the applications used by one or more users in the address book contact information of the first user, the network entity 306 may be triggered to send the capabilities request on behalf of the first user. In this way the network entity 306 may then display the capability information to the user via the web browser or even send the capabilities information direct to the UE 303 of the first user, when received the UE 303 displays the capabilities information to the first user appropriately. This provided the advantage that the UE 303 of the first user does not need to download the application should it be found that not many of the other users 304 in the address book contact information of the first user actually use the application. The UE may then select another appropriate application based on the capabilities information displayed to the first user.

FIG. 3c is another schematic illustration of a communication system taking advantage of the Network Address Book (NAB) system, which stores the capabilities of the user's contacts or a user's address book contact information in the communication network or IP network (not shown) in a server or database 305. The NAB system may be a database 305 of address book contact information for each user, which includes the capabilities of each user's contacts. NAB allows applications or other servers to get address book contact information and to receive updates on address book contact information (i.e. new contact added, contact information modified, etc.). Retrieve operations may return a list of contacts or a list of the user's address book contact information. For example, the types of applications or IARI's may be stored in the address book contact information for each user. As shown in FIG. 3b, the Extensible Mark-up Language (XML) Capabilities (XCAP) protocol may be used. In this example, an XCAP query or message (e.g. XCAP GET) is sent from the first user's UE 303 to a contact information server 302/305 e.g. the contact information server 302/305 may include the functionality of Presence and Group Management (PGM), Network Address Book (NAB) system, and/or XML Document Management server (XDMS). The contact information server 302/305 (e.g. PGM/XDMS/NAB) goes through the list of capabilities stored for the contacts of the user (i.e. for the users in the address book contact information of the user). The list of capabilities may be the applications used by the contacts of the user, i.e. the IARIs of applications used by the contact or the determined applications. The contact information server (PGM) returns the information back to the UE in a XML Document. The UE displays the information to the user.

In determining the applications that are used by the one or more other users, the contact information server 302 may calculate the number of contacts or users that use each capability or application (e.g. each determined application or IARI) on the list, where the capability information includes the number of users using each determined application on the list. Alternatively or additionally, the contact information server 302 may calculate the percentage of contacts or users in the address book contact information that use each capability or application (e.g. each determined application or IARI) on the list, where the capability information includes the percentage of users using each determined application on the list. Alternatively or additionally, the contact information server 302 may also determine the download location of each of the capabilities or applications (e.g. determined application(s)) on the list, where the capability information includes the determined download location(s) of the determined application(s).

In this example, the contact information server 302/305 send an XCAP response message (e.g. XCAP 200 OK) to the UE 303, in which the capability information includes data representative of the list of IARIs (e.g. determined application(s)), the application name, the percentage of users or contacts using each determined application, and the download location (e.g. Uniform Resource Locator). The contact information server 302/305 sends an XCAP response message of the form: XCAP 200 OK (list of IARIs, application name, percentage of users/contacts using each application, download URL).

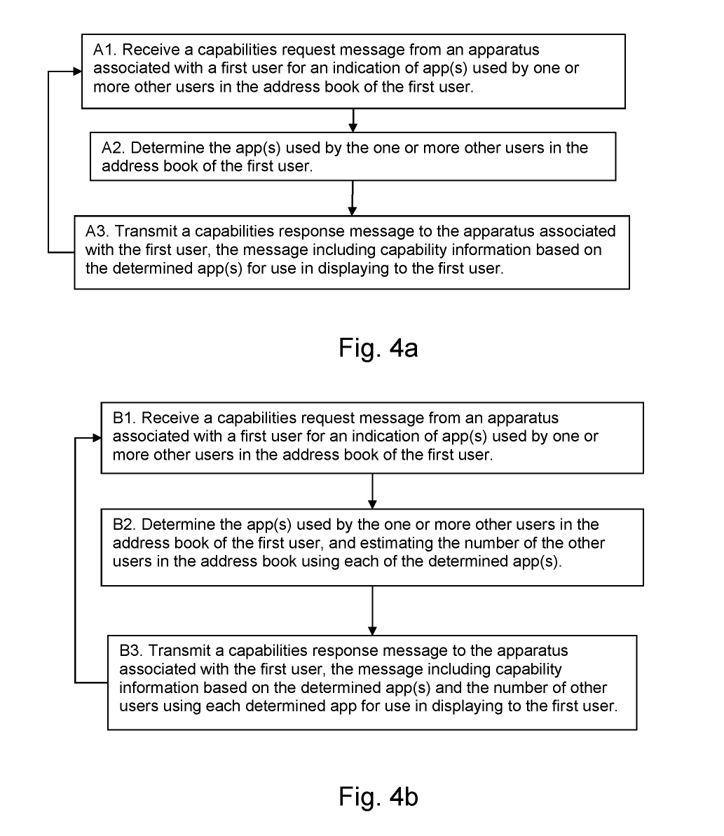

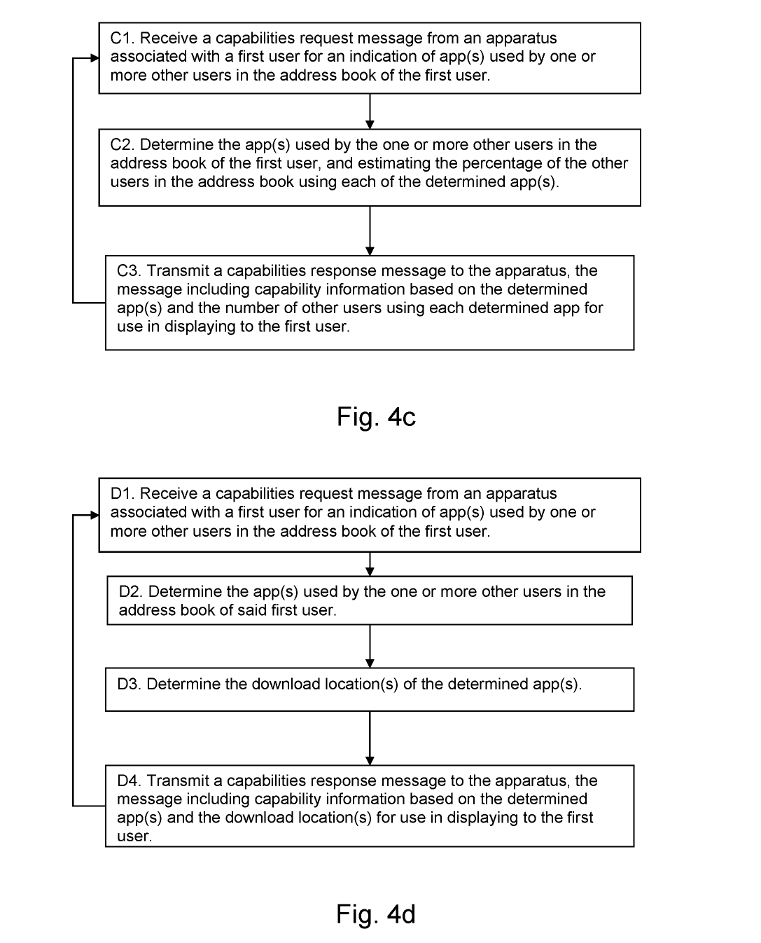

FIG. 4a illustrates an example process for use by a contact information server in an communications or IP network (e.g. an IMS network comprising one or more IMS Core networks). The IP network including the contact information server and a plurality of UE, where the contact information server is coupled to a database of address book contact information associated with users of the UE. Each user has address book contact information associated with one or more other users and each UE has one or more application(s) installed. The method or process performed by the contact information server is as follows:
A1. Receiving a capabilities request message from an apparatus associated with a first user for an indication of the applications used by one or more other users in the address book contact information of the first user.
A2. Determining the application(s) used or installed by the one or more other users in the address book contact information of the first user.
A3. Transmitting a capabilities response message to the apparatus associated with the first user, the capabilities response message including capability information representative of the determined application(s) for display to the first user.

The apparatus associated with the first user may be a UE or part of a UE of the first user. Alternatively, the apparatus associated with the first user may be a network entity or part of a network entity that operates on behalf of the first user. In addition, when determining the application(s) used or installed, the contact information server may query the database of address book contact information to retrieve the necessary data for use in determining the determined applications used by the one or more other users.

FIG. 4b is a flow diagram illustrating another example process for use by a contact information server in an communications or IP network (e.g. an IMS network comprising one or more IMS Core networks). The IP network including the contact information server and a plurality of UE, where the contact information server is coupled to a database of address book contact information associated with users of the UE. Each user has address book contact information associated with one or more other users and each UE has one or more application(s) installed. The method or process performed by the contact information server is as follows:
B1. Receiving a capabilities request message from an apparatus associated with a first user, or from a network entity on behalf of the first user, for an indication of the applications used by one or more other users in the address book contact information of the first user.
B2. Determining the application(s) used or installed by the one or more other users in the address book contact information of the first user, and estimating the number of one or more other users in the address book contact information of the first user that use each of the determined applications.
B3. Transmitting a capabilities response message to the an apparatus associated with the first user, the capabilities response message including capability information representative of the determined application(s) and information representative of the number of one or more other users using each determined application for display to the first user.

The apparatus associated with the first user may be a UE or part of a UE of the first user. Alternatively, the apparatus associated with the first user may be a network entity or part of a network entity that operates on behalf of the first user. In addition, when determining the application(s) used or installed, the contact information server may query the database of address book contact information to retrieve the necessary data for use in determining the determined applications and estimating the number of one or more users that use each of the determined applications.

FIG. 4c is a flow diagram illustrating another example process for use by a contact information server in an communications or IP network (e.g. an IMS network comprising one or more IMS Core networks). The IP network including the contact information server and a plurality of UE, where the contact information server is coupled to a database of address book contact information associated with users of the UE. Each user has address book contact information associated with one or more other users and each UE has one or more application(s) installed. The method or process performed by the contact information server is as follows:
C1. Receiving a capabilities request message from an apparatus associated with a first user for an indication of the applications used by one or more other users in the address book contact information of the first user.
C2. Determining the application(s) used or installed by the one or more other users in the address book contact information of the first user, and estimating the percentage of one or more other users in the address book contact information of the first user that use each of the determined applications.
C3. Transmitting a capabilities response message to the apparatus associated with the first user, the capabilities response message including capability information representative of the determined application(s) and information representative of the percentage of one or more other users using each determined application for display to the first user.

The apparatus associated with the first user may be a UE or part of a UE of the first user. Alternatively, the apparatus associated with the first user may be a network entity or part of a network entity that operates on behalf of the first user. In addition, when determining the application(s) used or installed, the contact information server may query the database of address book contact information to retrieve the necessary data for use in determining the determined applications and estimating the percentage of one or more users that use each of the determined applications.

FIG. 4d is a flow diagram illustrating a further process for use by a contact information server in a communications or IP network (e.g. an IMS network comprising one or more IMS Core networks). The IP network including the contact information server and a plurality of UE, where the contact information server is coupled to a database of address book contact information associated with users of the UE. Each user has address book contact information associated with one or more other users and each UE has one or more application(s) installed. The further method or process performed by the contact information server is as follows:
D1. Receiving a capabilities request message from an apparatus associated with a first user for an indication of the applications used by one or more other users in the address book contact information of the first user.
D2. Determining the application(s) used or installed by the one or more other users in the address book contact information of the first user.
D3. Determining the download location of each of the determined application(s), wherein the capability information includes the determined download location(s) of the determined application(s).
D4. Transmitting a capabilities response message to the apparatus associated with the first user, the capabilities response message including capability information representative of the determined application(s) and download locations of the determined application(s) for display to the first user.

The apparatus associated with the first user may be a UE or part of a UE of the first user. Alternatively, the apparatus associated with the first user may be a network entity or part of a network entity that operates on behalf of the first user. In addition, when determining the application(s) used, or the download locations, the contact information server may query the database of address book contact information to retrieve the necessary data for use in determining the determined applications and download locations.

Although the methods of FIGS. 4a-4d are illustrated as separate examples, it is to be appreciated by the person skilled in the art that one or more steps of each of these methods may be combined together.

In addition, the above processes or methods of FIGS. 4a-4d may use any appropriate communications protocol for communicating the capabilities request messages and capabilities response messages. For example, the capabilities request message and the capabilities response message are based on the XCAP protocol, in which the capabilities request message is an XCAP GET message and the capabilities response message is an XCAP 200 OK message. In addition, the capabilities request message may be embedded in a SIP request message and the capabilities response message is embedded in a SIP response message. It is to be appreciated that other protocols or messaging mechanisms may be used, for example, the OPTIONS mechanism or Presence mechanism may be used with equivalent capability information being determined and sent to the apparatus, UE or network entity.

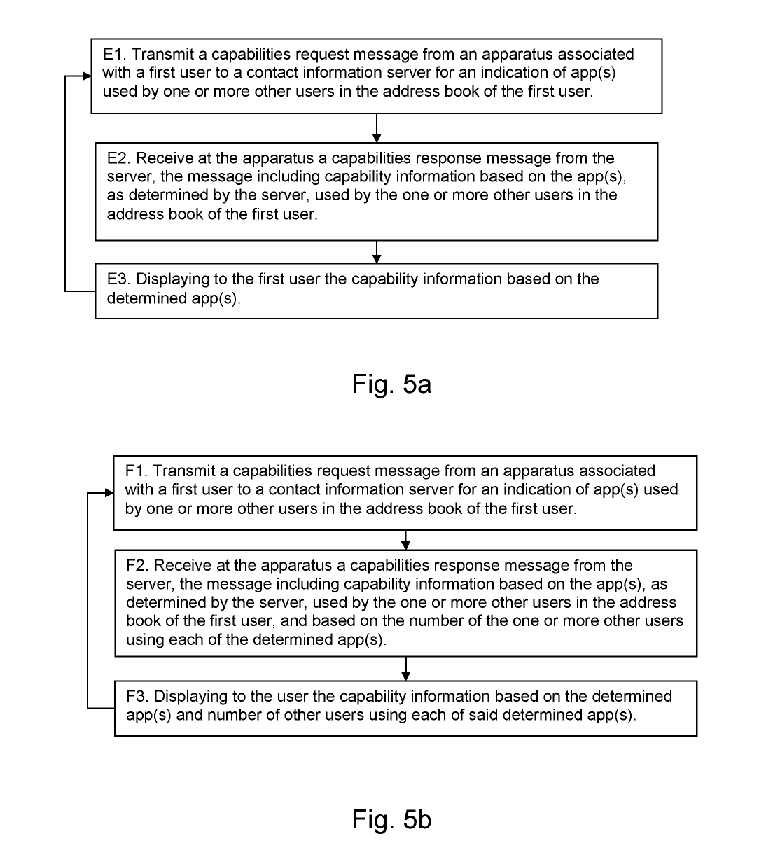

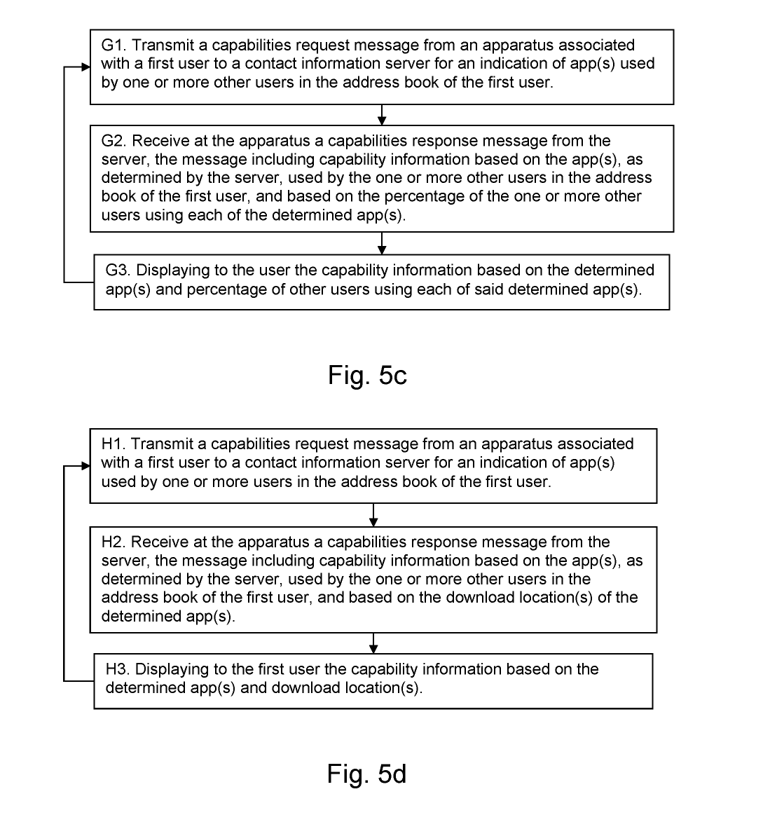

FIG. 5a is a flow diagram illustrating an example process performed by an apparatus associated with a first user in a communication network or IP network. The communication network comprising a contact information server, the contact information server is coupled to a database of address book contact information associated with the first user and a plurality of users of UE. Each user has address book contact information associated with one or more other users and each UE has one or more application(s) installed. The process or method performed by the apparatus associated with the first user is as follows:
E1. Transmitting a capabilities request message to the contact information server for an indication of applications that are used by one or more other users in the address book contact information of the first user.
E2. Receiving a capabilities response message from the contact information server, the capabilities response message comprising capability information representative of the application(s), as determined by the contact information server, that are used by the one or more other users in the address book contact information of the first user.
E3. Displaying the usage of the determined application(s) to the first user based on the received capability information.

The apparatus associated with the first user may be a UE or part of a UE of the first user. Alternatively, the apparatus associated with the first user may be a network entity or part of a network entity that operates on behalf of the first user.

FIG. 5b is a flow diagram illustrating another example process performed by an apparatus associated with a first user in a communication network or IP network. The IP network comprising a contact information server, the contact information server is coupled to a database of address book contact information associated with the first user and a plurality of users of UE. Each user has address book contact information associated with one or more other users and each UE has one or more application(s) installed. The example process or method performed by the apparatus associated with the first user is as follows:
F1. Transmitting a capabilities request message to the contact information server for an indication of applications that are used by one or more other users in the address book contact information of the first user.
F2. Receiving a capabilities response message from the contact information server, the capabilities response message comprising capability information representative of the application(s), as determined by the contact information server, that are used by the one or more other users in the address book contact information of the first user and information representative of the number of one or more other users that use each determined application.
F3. Displaying the usage of the determined application(s) to the first user based on the received capability information.

The apparatus associated with the first user may be a UE or part of a UE of the first user. Alternatively, the apparatus associated with the first user may be a network entity or part of a network entity that operates on behalf of the first user.

FIG. 5c is a flow diagram illustrating a further example process performed by an apparatus associated with a first user in a communication network or IP network. The communication network comprising a contact information server, the contact information server is coupled to a database of address book contact information associated with the first user and a plurality of users of UE. Each user has address book contact information associated with one or more other users and each UE has one or more application(s) installed. The example process or method performed by the apparatus associated with the first user is as follows:
G1. Transmitting a capabilities request message to the contact information server for an indication of applications that are used by one or more other users in the address book contact information of the first user.
G2. Receiving a capabilities response message from the contact information server, the capabilities response message comprising capability information representative of the application(s), as determined by the contact information server, that are used by the one or more other users in the address book contact information of the first user and information representative of an estimated percentage of the one or more other users that use each of the determined application(s) on the corresponding UE.
G3. Displaying the usage of the determined application(s) to the first user based on the received capability information.

The apparatus associated with the first user may be a UE or part of a UE of the first user. Alternatively, the apparatus associated with the first user may be a network entity or part of a network entity that operates on behalf of the first user.

FIG. 5d is a flow diagram illustrating yet a further example process performed by an apparatus associated with a first user in a communication network or IP network. The IP network comprising a contact information server, the contact information server is coupled to a database of address book contact information associated with the first user and a plurality of users of UE. Each user has address book contact information associated with one or more other users and each UE has one or more application(s) installed. The process or method performed by the apparatus associated with the first user is as follows:
H1. Transmitting a capabilities request message to the contact information server for an indication of applications that are used by one or more other users in the address book contact information of the first user.
H2. Receiving a capabilities response message from the contact information server, the capabilities response message comprising capability information representative of the application(s), as determined by the contact information server, that are used by the one or more other users in the address book contact information of the first user and information representative of download location(s) of the determined application(s).
H3. Displaying the usage of the determined application(s) to the first user based on the received capability information.

The apparatus associated with the first user may be a UE or part of a UE of the first user. Alternatively, the apparatus associated with the first user may be a network entity or part of a network entity that operates on behalf of the first user.

Although the methods of FIGS. 5a-5d are illustrated as separate examples, it is to be appreciated by the person skilled in the art that one or more steps of each of these methods may be combined together.

In addition, the above methods of FIGS. 5a-5d may use any appropriate communications protocol for communicating the capabilities request messages and capabilities response messages. For example, the capabilities request message and the capabilities response message are based on the XCAP protocol, in which the capabilities request message is an XCAP GET message and the capabilities response message is an XCAP 200 OK message. In addition, the capabilities request message may be embedded in a SIP request message and the capabilities response message is embedded in a SIP response message. It is to be appreciated that other protocols or messaging mechanisms may be used, for example, the OPTIONS mechanism or Presence mechanism may be used with equivalent capability information being determined and sent to the apparatus, UE or network entity.

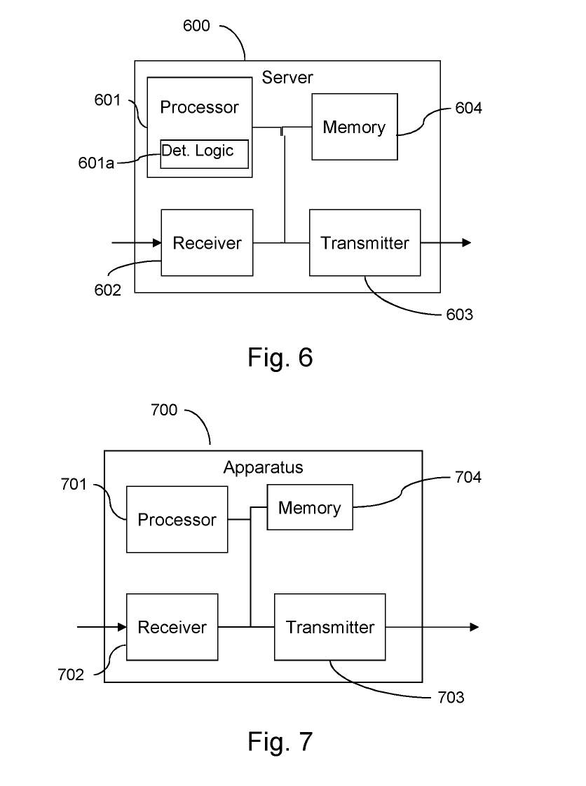

FIG. 6 is a schematic illustration of a server 600 (e.g. a contact information server) for use in a communication network such as an IP network comprising a plurality of UE. The server 600 is coupled to a database of address book contact information associated with users of the plurality UE. Each user has address book contact information associated with one or more other users and each UE has one or more application(s) installed.

The server 600 includes a processor 601, receiver 602, transmitter 603 and memory 604, the processor 601 being coupled to the receiver 602, the transmitter 603 and the memory 604. The memory 604 may include the database of address book contact information, or the server 600 may be communicatively coupled via receiver 602 and transmitter 603 to the database of address book contact information.

In operation, the receiver 602 is configured to receive a capabilities request message from a UE of a first user (or from an apparatus associated with the first user or network entity operating on behalf of the first user) for an indication of applications used by one or more other users in address book contact information of the first user. The processor 601 comprises determining logic 601a configured to determine the application(s) that are used by the one or more other users in the address book contact information of the first user. The transmitter 603 is configured to transmit a capabilities response message to the UE of the first user (or to an apparatus associated with the first user or network entity operating on behalf of the first user), the capabilities response comprising capability information representative of the determined application(s) for display to the first user.

In addition, the determining logic 601a may be further configured to estimate the number of one or more other users in the address book contact information of the first user that use each of the determined applications. The capability information may then include information representative of the number of one or more other users that use each determined application. Alternatively or additionally, determining logic 601a may be further configured to estimate a percentage of the one or more other users in the address book contact information of the first user that use each of the determined application, where the capability information further includes the estimated percentages for each of the determined application(s). In addition, the determining logic 601a may be further configured to determine the download location of each of the determined application(s), where the capability information includes the determined download location(s) of the determined application(s).

FIG. 7 is a schematic illustration of an apparatus 700 associated with a first user (e.g. a UE of a first user or a network entity operating on behalf of the first user) for use in a communications network such as an IP network. The communications network may comprise a server 600 (or contact information server 302), the server 600 being coupled to a database of address book contact information associated with a plurality of users and associated UE in the IP network, where each user has address book contact information associated with one or more other users and each UE has one or more application(s) installed.

The apparatus 700 includes a processor 701, receiver 702, transmitter 703, memory 704 and a display(not shown in FIG. 7), the processor 701 being coupled to the receiver 702, the transmitter 703, and the memory 704. In operation, the transmitter 703 is configured to transmit a capabilities request message to the contact information server for an indication of applications used by one or more other users in the address book contact information of a first user of said UE 700. The receiver 702 is configured to receive a capabilities response message from the contact information server, the capabilities response message comprising capability information representative of the application(s), as determined by the contact information server, that are used by the one or more other users in the address book contact information of the first user. The processor 701 is configured to process the capability information for use in displaying the capability information to the first user.

In addition, the capability information may further include information representative of the number of one or more other users that use each of the determined application(s). Alternatively or additionally, the capability information may further include an estimated percentage of the one or more other users that use each of the determined application(s). In addition, the capability information may further include download location(s) of the determined application(s). If the apparatus 700 is a UE, then the capability information may be processed and displayed on a display of the UE. If the apparatus 700 is a network entity, then the capability information may be processed for use in displaying to the first user, e.g. via a web browser on the display of the UE of the first user.

The servers, UEs, network entities, apparatus and computing systems as described herein each may perform the methods and processes as described herein. The processors of such systems are configured to execute computer program instructions based on the methods and processes described herein, such instructions being contained in a computer-readable medium or non-transitory computer readable medium, such as memory. The computer program instructions may be read into memory from another computer-readable medium or from another device via a communication interface. The instructions contained in memory cause the processor of a client device, reputation system, server, or other such computer system to perform processes or methods as described herein. Alternatively or in addition to, hardwired circuitry may be used in place of or in combination with the computer program instructions to implement processes and methods consistent with the present invention. Examples of hardware circuitry may include, but are not limited to, semiconductor chips, integrated circuits, field programmable gate arrays, application-specific integrated circuits, electronically programmable integrated circuits and the like. Thus, the present invention is not limited to any specific combination of hardware circuitry and/or software.

In addition, there is provided a computer program, comprising computer readable code means which, when run from a computer readable medium in the form of a memory in a processor in a server, causes the server to perform the methods or processes as described. Additionally or alternatively, there is provided a computer program product comprising a computer readable medium and a computer program as described, where the computer program is stored on the computer readable medium. Further, there is provided a computer program, comprising computer readable code means which, when run from a computer readable medium in the form of a memory in a processor in an apparatus, UE or network entity, causes the apparatus, UE or network entity to perform the methods or processes as described. As an option, there is provided a computer program product comprising a computer readable medium and a computer program as described, where the computer program is stored on the computer readable medium.

Although the invention has been described in terms of example solutions or preferred embodiments as set forth above, it should be understood that these examples or embodiments are illustrative only and that the claims are not limited to only those examples or embodiments. Those skilled in the art will be able to make modifications and alternatives in view of the disclosure which are contemplated as falling within the scope of the appended claims. Each of the features, steps, servers or apparatus disclosed or illustrated in the present specification may be incorporated into the invention, whether alone or in any appropriate combination with any other feature, step, or node disclosed or illustrated herein.

1. A method for use by a contact information server in an IP network, the IP network including the contact information server and a plurality of user equipment, wherein the contact information server is coupled to a database of address book contact information associated with users of the user equipment-in the IP network, wherein each user has address book contact information associated with one or more other users and each user equipment has one or more application(s) installed, the method comprising:
receiving a capabilities request message from an apparatus associated with a first user for an indication of the applications used by one or more other users in the address book contact information of the first user;
determining the application(s) used or installed by the one or more other users in the address book contact information of the first user; and
transmitting a capabilities response message to the apparatus associated with the first user, the capabilities response comprising capability information representative of the determined application(s) for use in displaying to the first user.

2. The method of claim 1, wherein the step of determining the application(s) used further comprises estimating the number of one or more other users in the address book contact information of the first user that use each of the determined applications, wherein the capability information further includes information representative of the number of one or more other users using each determined application.

3. The method of claim 1, wherein the step of determining the applications used further comprises estimating a percentage of the one or more other users that use each of the determined application(s), wherein the capability information further includes the estimated percentages for each of the determined application(s).

4. The method of claim 1, further comprising determining the download location of each of the determined application(s), wherein the capability information includes the determined download location(s) of the determined application(s).

5. The method of claim 1, wherein the capabilities request message and the capabilities response message are based on the XCAP protocol.

6. The method of claim 5, wherein the capabilities request message is an XCAP GET message and the capabilities response message is an XCAP 200 OK message.

7. The method of claim 5, wherein the capabilities request message is embedded in a SIP request message and the capabilities response message is embedded in a SIP response message.

8. The method of claim 1, wherein a user equipment of the first user comprises the apparatus, wherein the capabilities request message is received from the user equipment of the first user, and the capabilities response message is transmitted to the user equipment of the first user, wherein the user equipment displays the capability information to the first user.

9. The method of claim 1, wherein a network entity comprises the apparatus, wherein the capabilities request message is received from a network entity on behalf of the first user, and the capabilities response message is transmitted to the network entity, wherein the network entity displays the capability information to the first user.

10.-18. (canceled)

19. A contact information server for use in an network comprising a plurality of user equipment, the contact information server coupled to a database of address book contact information associated with users of the plurality user equipment, wherein each user has address book contact information associated with one or more other users and each user equipment has one or more application(s) installed, the contact information server comprising:
a processor, receiver, transmitter and memory, the processor being coupled to the receiver, the transmitter and the memory, wherein:
the receiver is operable to receive a capabilities request message from an apparatus associated with a first user for an indication of applications used by one or more other users in address book contact infoiniation of the first user; and
the processor is configured to determine the application(s) that are used by the one or more other users in the address book contact information of the first user, and is configured to employ the transmitter to transmit a capabilities response message to the apparatus associated with the first user, the capabilities response comprising capability infoiiiiation representative of the determined application(s) for display to the first user.

20. The server of claim 19, wherein the determining logic is further configured estimate the number of one or more other users in the address book contact information of the first user that use each of the determined applications, wherein the capability information includes information representative of the number of one or more other users that use each determined application.

21. The server of claim 19, wherein the determining logic is further configured to estimate a percentage of the one or more other users in the address book contact information of the first user that use each of the determined application(s), wherein the capability information includes the estimated percentages for each of the determined application(s).

22. The server of claim 19, wherein the determining logic is further configured to determine the download location of each of the determined application(s), wherein the capability information includes the determined download location(s) of the determined application(s).

23. The server of claim 19, wherein the capabilities request message and the capabilities response message are based on the XCAP protocol.

24. The server of claim 19, wherein a user equipment of the first user comprises the apparatus.

25. The server of claim 19, wherein a network entity operating on behalf of the first user comprises the apparatus.

26. An apparatus for use in an IP network comprising a contact information server, the contact information server coupled to a database of address book contact information associated with a plurality of users and associated user equipment in the IP network, wherein each user has address book contact information associated with one or more other users and each user equipment has one or more application(s) installed, the apparatus comprising:
a processor, receiver, transmitter, memory and a display, the processor being coupled to the receiver, the transmitter, the memory and the display, wherein:
the transmitter configured to transmit a capabilities request message to the contact information server for an indication of applications used by one or more other users in the address book contact information of a first user of said user equipment;
the receiver is configured to receive a capabilities response message from the contact information server, the capabilities response message comprising capability information representative of the application(s), as determined by the contact information server, that are used by the one or more other users in the address book contact information of the first user; and
the processor is configured to process the capability information for displaying the capability information to the first user on the display.

30. (canceled)

31. A computer program, comprising computer readable code means which, when run from a computer readable medium in the form of a memory in a processor in a server, causes the server to perform the method of any of claims 1 to 9.

32. A computer program product comprising a non-transitory computer readable medium storing a computer program for configuring a server to perform the method of claim 1.

33.-34. (canceled)
